(19) United States
(12) Patent Application Publication
(10) Pub. No.: US 2008/0133897 A1
(43) Pub. Date: Jun. 5, 2008

(54) Diagnostic apparatus and method

(75) Inventors: Alastair David Reid, Cambridge (GB); Simon Andrew Ford, Cambridge (GB); Katherine Elizabeth Kneebone, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/907,112

(22) Filed: Oct. 9, 2007

Related U.S. Application Data
(60) Provisional application No. 60/853,756, filed on Oct. 24, 2006.

(30) Foreign Application Priority Data
Sep. 11, 2007 (GB) 0717706.6

(51) Int. Cl. G06F 9/30

(52) U.S. Cl. 712/227; 712/220; 712/E09.016

(57) ABSTRACT

A diagnostic method is described for generating diagnostic data relating to processing of an instruction stream, wherein said instruction stream has been compiled from a source instruction stream to include multiple threads, said method comprising the steps of:
(i) initiating a diagnostic procedure in which at least a portion of said instruction stream is executed;
(ii) controlling a scheduling order for executing instructions within said at least a portion of said instruction stream to cause execution of a sequence of thread portions, said sequence being determined in response to one or more rules, at least one of said rules defining an order of execution of said thread portions to follow an order of said source instruction stream.

In this way, the diagnostic method can generate a debug view of a parallelised program which is the same as, or at least similar to, a debug view which would be provided when debugging the original non-parallelised program.

### FIELD OF INVENTION

The present invention relates to a diagnostic apparatus and a corresponding method for generating diagnostic data relating to processing of an instruction stream.

### BACKGROUND OF THE INVENTION

Computer programs are typically subject to intensive testing and debugging in order to ensure they will function reliably when executed. Where a computer program has been compiled from source code, such testing and debugging should also be carried out on the compiled program. One particular type of compiler can transform a program with only one sequence of instructions into a program with multiple sequences of instructions (referred to hereinafter as multiple threads) which can, to a certain degree, be executed in parallel if run on a multi-processor system. Such a compiler may be referred to as a parallelising compiler. While a multi-threaded program generated in this way can make efficient use of system resources when executed on a multi-processor system, it becomes difficult to debug the compiled program because the debugger view of the source program may be completely different from the debugger view which would be provided in respect of the source program. In particular, it may not be possible to set breakpoints at the same positions in the program (for example inside loops that have been parallelised), and different runs of the program on the same data may provide different debug views depending on how the debugger is invoked.

Additionally, a problem with parallel programs is that testing a multi-threaded program can be problematic because the behaviour of the program can, often incorrectly, depend on the precise timing behaviour of the different threads, and a small perturbation of the system, due for instance to inputs of other users or bus contention, can affect that timing.

The above problems are particularly apparent in the case of system-on-chip (SoC) devices, which are widely available in the form of consumer electronic devices such as mobile phones. SoC devices may rely heavily on parallel processing in order to provide high performance and low power consumption. Additionally, as embedded systems, the debugging of software applications on SoC devices is more difficult and requires the use of external hardware and software. It is thus highly desirable in this context to provide an improved and more programmer-friendly mechanism for debugging parallel programs.

### SUMMARY OF INVENTION

According to one aspect of the present invention, there is provided a diagnostic method for generating diagnostic data relating to processing of an instruction stream, wherein said instruction stream has been compiled from a source instruction stream to include multiple threads, said method comprising the steps of:

(i) initiating a diagnostic procedure in which at least a portion of said instruction stream is executed;
(ii) controlling a scheduling order for executing instructions within said at least a portion of said instruction stream to cause execution of a sequence of thread portions, said sequence being determined in response to one or more rules, at least one of said rules defining an order of execution of said thread portions to follow an order of said source instruction stream.

The present invention addresses the above problems by allowing the diagnostic procedure to generate a debug view of a parallelised program which is the same as, or at least similar to, a debug view which would be provided when debugging the original non-parallelised program. This makes it easier for the programmer to debug the parallelised program, because the order of execution of instructions in the parallelised program will be at least similar to the order of execution of the respective instructions in the original non-parallelised program, which the programmer will have written himself, and thus will understand. Additionally, this diagnostic procedure will provide a more consistent debug view of the parallelised program, because the timing behaviour of the different threads of the program can be controlled by the one or more rules. Clearly, it is desirable for the order of execution of the parallel program to be as close as possible to the order of execution of the original program, and thus preferably at least one of said rules defines an order of execution of said thread portions which substantially matches an order of said source instruction stream. It should be appreciated that the rule defining an order of the source instruction stream may specify that order and try to apply it to the compiled instruction stream but may in some circumstances be overridden by other rules. For instance a rule ensuring that the parallel program meets deadlines for performing an intended function may override the rule defining the order of the source instruction stream.

The above advantages are not exhibited by existing debuggers for parallel programs, which often restrict the debug view at a given time to only those parts of the parallel program which correspond to the original source program. For example, if the program initialises a data structure, then splits into four threads to modify the data structure, then waits for the four threads to complete before continuing execution, then the debugger may disallow observation of operations on the data structure during the time that multiple threads are modifying it, because the state of the data structure may not reflect any valid state of the original unthreaded program. Other existing debuggers may allow the programmer to observe any operation at any point in the parallel program, but will require the programmer both to understand how the program was parallelised, and to directly debug the multithreaded program, which is considerably harder to do. The present invention seeks to reduce the programmer's exposure to the parallelism of the multithreaded program.

Embodiments of the present invention may be applied to system-on-chip (SoC) devices.

In some embodiments said at least one of said rules defines an order of execution of said thread portions which substantially matches an order of said source instruction stream. This is clearly the easiest arrangement to debug, however, it may not always be possible to provide such an order of execution.

It will be appreciated that while the source program could consist of a single thread, which is then compiled (parallelised) to include multiple threads, the source program could itself be a parallel program, which is then compiled to increase parallelism by adding further threads. In this latter case, the diagnostic procedure may generate a debug view which exposes the programmer to some parallelism, in particular the parallelism of the original program, but this will still be easier for the programmer to understand and debug than the fully multithreaded object program.

In some embodiments one of the rules may comprise:

detecting when execution of a currently executing thread reaches a switching point in said instruction stream, and blocking said currently executing thread from further execution; and

determining a currently inactive thread which is runnable, and executing said instruction stream associated with said currently inactive thread.

This rule may serve to perform one or both of inhibiting parallelism, and reducing thread interleaving, either or both of which will tend to result in an instruction execution order similar to that of the original source code, in which parallelism is either not present or reduced, and potential threads of instructions are often set out in a non-interleaved manner. The effectiveness of this rule in modifying the instruction execution order to reduce parallelism and to match the original source code order may depend on the switching points used. For instance, one or more of the switching points may be communication points between threads which occur when a currently executing thread makes a value available to another thread. This may particularly be the case where variables are not shared between different threads, but a value to be shared between threads is instead passed from one thread to another over a communication channel. When a value is passed between threads in this way, it will often be the case that the flow of execution should switch from one thread to another in the debug mode in order to mimic the order of execution of the original source program.

One or more of the switching points may be a synchronisation point at which one or more threads switches from a runnable state to a non-runnable state, or from a non-runnable state to a runnable state.

Communication points and synchronisation points are particularly suitable for use as switching points, because they can be readily discerned from the parallel code.

Communication points and synchronisation points are types of switching point which are inherently present in the compiled program code. It may however be necessary to add switching points to the program code to facilitate the modified scheduling order required to execute the parallel code in the same order as the original code. In this case, one or more thread yield instructions may be added by a compiler as switching points when the source instruction stream is compiled. Such a thread yield instruction may for instance be added to a thread when a compilation of an instruction from the source instruction stream does not generate a corresponding instruction in that thread.

The above switching points are provided within the object program code itself. However, it is also possible to add one or more breakpoints during execution of said instruction stream as switching points. This can be done either as an alternative to the use of communication points, synchronisation points and/or thread yield instructions, or as additional switching points. A position of the breakpoints may be determined from data generated by a compiler during a compilation of the source instruction stream.

One or more of the rules used to define the scheduling order may be generated from sequence data which was in turn generated during compilation of the instruction stream from the source instruction stream, with the sequence data being indicative of an order of the source instruction stream. The sequence data may be a discrete file, or may form part of a debug map which provides a correspondence between instructions of the source code and instructions of the object code.

According to another aspect of the invention, there is provided a diagnostic apparatus for generating diagnostic data relating to processing of an instruction stream, wherein said instruction stream has been compiled from a source instruction stream to include multiple threads, said diagnostic apparatus comprising:

a diagnostic engine for initiating a diagnostic procedure in which at least a portion of said instruction stream is executed; and

a scheduling controller for controlling a scheduling order for executing instructions within said at least a portion of said instruction stream to cause execution of a sequence of thread portions determined in response to one or more rules, at least one of said rules defining an order of execution of said thread portions to follow an order of said source instruction stream.

According to another aspect of the invention, there is provided a method of compiling an instruction stream from a source instruction stream to include multiple threads, comprising the step of:

generating sequence data during compilation of said source instruction stream, said sequence data being indicative of an order of said source instruction stream.

According to another aspect of the invention, there is provided a parallelising compiler for compiling an instruction stream from a source instruction stream to include multiple threads, the compiler comprising:

a sequence data generator operable to generate sequence data during compilation of said source instruction stream, said sequence data being indicative of an order of said source instruction stream.

Various other aspect and features of the present invention are defined in the claims, and include a computer program product.

The above, and other objections, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing system which is capable of performing multiple data processing tasks in parallel;

FIG. 2 schematically illustrates a parallelising compiler;

FIG. 3 schematically illustrates an example program execution flow for respective source code, object code and rescheduled code;

FIG. 4 schematically illustrates the data processing system of FIG. 1 in a test configuration along with a development system; and

FIG. 5 is a schematic flow diagram illustrating a diagnostic method in accordance with the present technique.

### DESCRIPTION OF THE PREFERRED EMBODIMENTS

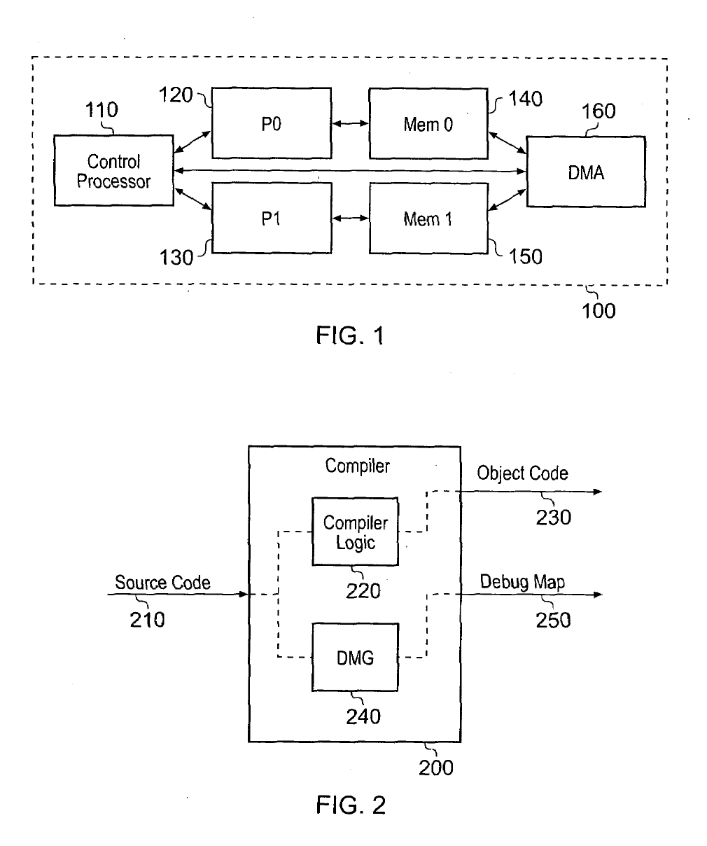

Referring to FIG. 1, a data processing system 100 is schematically illustrated which is capable of performing multiple data processing tasks in parallel. This is achieved by providing a control processor 110, a first processor (P0) 120 and a second processor (PI) 130. The control processor 110 provides overall control of data processing operations on the data processing system 100, and is operable to delegate tasks to one or both of the first processor 120 and second processor 130 for parallel execution. In particular, the control processor 110 serves as a scheduler for scheduling, in accordance with certain rules, an order in which groups of instructions are to be executed by the first processor 120 and the second processor 130. In the present example, each of the first processor 120 and the second processor 130 has a dedicated memory. Specifically, the first processor 120 has a dedicated first memory 140 and the second processor 130 has a dedicated second memory 150. Transfer of data between the first memory 140 and the second memory 150 is conducted using a DMA (Direct Memory Access) controller 160 under control of the control processor 110. In an alternative example a shared memory could be used by both the first processor 120 and the second processor 130, which would simplify the apparatus of FIG. 1 due to the reduced need for the DMA controller 160 but would require careful control over the shared memory to avoid memory access conflicts between the first processor 120 and the second processor 130 when executing instructions in parallel.

Program code for execution by a data processing system basically comprises a list of instructions which are traditionally executed sequentially by a processor. While this list is often broken down into multiple functions and sub-routines, it would traditionally still be executed sequentially, with the processor executing each instruction in turn before moving on to the next instruction in the sequence. However, in the case of a multithreaded program, the list of instructions is constructed in such a way that certain instructions or groups of instructions can be executed at the same time on different processors. It will be appreciated that there will be limits to which instructions can be executed in parallel. For instance, there will be interrelationships in the program code which will require certain instructions to be executed before others. For example, in order for a variable var to be read, a value should previously have been assigned to the variable var, and so an instruction to read the variable var should not be executed until after the instruction to write a value to the variable var. Accordingly, it will be understood that certain elements of program code should be executed sequentially in order for them to function correctly. However, other elements of program code can be executed independently of each other, and thus can be executed in parallel on a multi-processor data processing system.

Two main types of program parallelism are possible. The first of these, task parallelism, occurs where two different tasks are executed in parallel, either on the same or different data. For example, in the context of FIG. 1, the control processor 110 may control the first processor 120 to perform a task P on data p, and the second processor 130 to perform a different task Q either on the data p or on different data q. Consider the following sequence of source code instructions:

| | |
|---|---|
| (a) | for (int i=0; i<N; ++i) { |

| | |
|---|---|
| (b) | int x=P( ); |
| (c) | Q(x); |

| | |
|---|---|
| (d) | } |

Instruction (a) sets up a loop in which a variable i is initialised to zero on first execution and then incremented by 1 for each cycle of the loop. The loop is specified to continue until the value of variable i reaches a value N. Within the loop, instruction (b) determines a value for a variable x in accordance with a function P( ), and instruction, (c) executes a function Q(_) on the value stored in variable x. Instruction (d) closes the loop. It will be understood that instructions (b) and (c) can be described as data processing instructions which perform an operation on data values, whereas instructions (a) and (d) constitute control instructions which control if and when the data processing instructions can be executed. Although data processing instruction (c) depends on a result of data processing instruction (b), it is possible to execute instructions (b) and (c) in parallel by executing instruction (c) on a value of x determined in the previous cycle of the loop while the current cycle of the loop determines a new value for x. This can be achieved by splitting instructions (a) to (d) into two threads as shown in Table 1:

TABLE 1

| Thread 1 | | Thread 2 | |
|---|---|---|---|
| (a₁) | for (int i=0; i<N; ++i) { | (a₂) | for (int i=0; i<N; ++i) { |

| | | | |
|---|---|---|---|
| (b₁) | int x=P( ); | (f) | int x=get(ch); |
| (e) | put(ch, x); | (c₂) | Q(x); |

| | | | |
|---|---|---|---|
| (d₁) | } | (d₂) | } |

It can be seen from Table 1 that thread 1 comprises control instructions (a₁) and (d₁) which correspond to the control instructions (a) and (d) of the original code and that thread 2 comprises control instructions (a₂) and (d₂) which also correspond to the control instructions (a) and (d) of the original code. Thread 1 includes a data processing instruction (b₁) which corresponds to the data processing instruction (b) of the original code, and also an instruction (e) which places the value of variable x generated by instruction (b₁) into a communication channel using a put command. Thread 1 does not include an instruction corresponding to data processing instruction (c) of the original code, because this is provided separately in thread 2. Thread 2 includes an instruction (f) which obtains a value x from the communication channel using a get command, and also includes a data processing instruction (c₂) which corresponds to the data processing instruction (c) of the original code. In particular, data processing instruction (c2) operates on the value of x obtained from the communication channel by instruction (f). Thread 2 does not include an instruction corresponding to data processing instruction (b) of the original code, because this is provided separately in thread 1. When executed, thread 1 generates a value for x at each cycle of the loop and places this value in a communication channel, where it can be obtained by thread 2 in the following cycle of the loop. While thread 2 is processing the value of x obtained from the communication channel, thread 1 will be generated a new value of x and placing it on the communication channel. In this way, data processing instructions (b) and (c) of the original code can be executed in parallel in a multithreaded version of the original code.

The other type of program parallelism, data parallelism, occurs where the same task is executed in parallel on different data. For example, in the context of FIG. 1, the control processor 110 may control the first processor 120 to perform a task R on data x and the second processor 130 to perform the task R on different data y.

Consider the following sequence of instructions:

| | |
|---|---|
| (j) | for (int i=0;i<100;++i){ |

| | |
|---|---|
| (k) | R(Input[i]); |

| | |
|---|---|
| (l) | } |

Instruction (j) sets up a loop in which a variable i is initialised to zero on first execution and then incremented by 1 for each cycle of the loop. The loop is specified to continue until the value of variable i reaches a value of 100. Within the loop, instruction (k) performs a function R on a value Input[i] of an array Input of values. Each cycle of the loop results in function R being performed on a different value within the array due to the fact that the index i to the array is incremented for each cycle. Instruction (l) closes the loop. It will be understood that instruction (k) can be described as a data processing instruction, whereas instructions (j) and (l) constitute control instructions. Parallelism can be introduced in this case by performing the function R on multiple different values concurrently. This can be achieved by splitting instructions (j) to (l) between two threads as shown in Table 2:

TABLE 2

| Thread 1 | | Thread 2 | |
|---|---|---|---|
| (j₁) | for (z=0; i<50; ++i) { | (j₂) | for (i=50; i<100; ++i) { |

| | | | |
|---|---|---|---|
| (k₁) | R(Input[i]); | (k₂) | R(Input[i]); |

| | | | |
|---|---|---|---|
| (l₁) | } | (l₂) | } |

It can be seen from Table 2 that thread 1 comprises control instructions (j₁) and (l₁) which mainly correspond to the control instructions (j) and (l) of the original code and that thread 2 comprises control instructions (j₂) and (l₂) which also mainly correspond to the control instructions (h) and (l) of the original code. Thread 1 includes a data processing instruction (k₁) which corresponds to the data processing instruction (k) of the original code, and thread 2 includes an instruction (k₂) which also corresponds to the data processing instruction (k) of the original code. However, the slight difference between instruction (j₁) and (j), and (j₂) and (j) provides the parallelism in this case. In particular, it can be seen that instruction (j₁) sets up a loop in which the variable i ranges from 0 to 49 compared with the range of 0 to 99 set up by instruction (j) of the original code, and that instruction (j₂) sets up a loop in which the variable i ranges from 50 to 99 compared with the range of 0 to 99 set up by instruction (j) of the original code. In this way, the first thread carries out function R in respect of one half of the array Input[ ] and the second thread carries out function R in respect of the other half of the array Input[ ]. In this way, the same data processing task, function R, can be executed in parallel using two threads on two separate processors using different data.

As described above, program code can be adapted to add parallelism, thereby enabling an increase in performance when executed on a multi-processor system. The addition of parallelism can be achieved by using a parallelising compiler as schematically illustrated in FIG. 2 to compile sequential source code into multithreaded object code. Referring to FIG. 2, a parallelising compiler 200 is provided which receives source code 210 as an input, and processes the source code 210 in accordance with predetermined rules defined by compilation logic 220 to generate and output object code 230 comprising a plurality of threads which can be processed in parallel. Additionally, the parallelising compiler 200 comprises a debug map generator (DMG) 240 which generates a debug map 250 providing information indicating a correspondence between instructions in the source code 210 and instructions in the object code 230. The parallelising compiler 200 could be implemented either in hardware or software, and could perform the parallelising compilation process either automatically, or with supplementary programmer input. Preferably, the debug map generator generates sequence data indicating an instruction order of the source code. The sequence data in the present case is provided as part of the debug map, but may instead be provided as a separate data file.

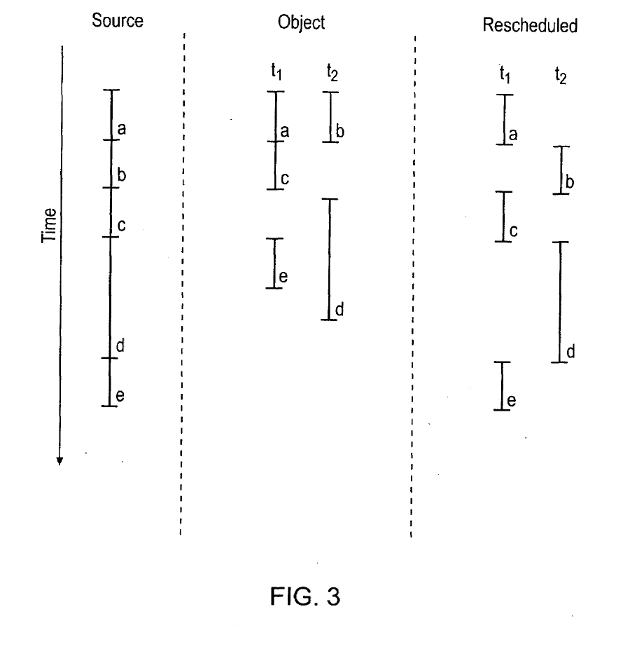

While the parallelism introduced by the parallelising compiler 200 makes the execution of the object code more efficient when run on a multi-processor system, the process of debugging the object code is, as described above, usually much more challenging, because the order in which instructions are executed may differ greatly from the order in which the corresponding instructions would be executed in the original source code. Accordingly, it is desirable when debugging the object code to execute or step through the object code in an order which mimics the original execution order of the source code. Referring to FIG. 3, the execution of program code as a function of time is schematically illustrated, for each of the source code (left hand column), the object code (middle column), and the object code as rescheduled to mimic the execution order of the source code (right hand column). As can be seen in FIG. 3, the source code consists of a single stream of execution, with instruction groups a, b, c, d and e being executed sequentially over time. The object code, which has been generated from the source code, includes two threads, t1 and t2, which are executed in parallel using respective different processors. Accordingly, in the object code instructions groups a and b are executed in parallel, and instruction groups d and e are executed in parallel. The rescheduled code also includes two threads, which are executed using respective different processors, but in this case the code has been forced to execute in the original execution order of the source code, and to execute sequentially rather than in parallel. In this manner, a more programmer-friendly debug view of code execution can be provided.

The rescheduling shown in FIG. 3 can be achieved by starting and stopping different threads of the program code in an order which causes the order of instruction execution to match that of the original sequential program code. When the program is executed in a debug mode, whenever a switching point in the program code is reached, a scheduling function of the control processor 110 is invoked and the scheduler selects which thread to run and blocks execution of all other threads. In this way, parallel execution is inhibited and an order of execution of the threads can be selected as desired. For the example threads shown in Table 1, the two threads communicate data between themselves via a communication channel, in this case a FIFO (First-In-First-Out) channel, using the put and get commands. If a programmer were to single step through the original sequential code instructions (a) to (d) from which the threads of Table 1 were derived, alternating calls to functions b and c would be seen. In order to achieve the same result in the parallel version, when the first thread puts a value into the channel using the put command, the current thread is blocked and the scheduler decides which thread to run next. At this point, there are two runnable threads, these being the thread that performed the put instruction and the thread which is currently blocked and is waiting to perform a get instruction. The scheduler should in this case start the thread that is blocked, because that thread includes the instruction which corresponds to the next line in the original sequential code. The effect of this process is that at any time at most one thread is running and the scheduler avoids running the other threads even if there are processing resources available to run them.

In addition to communication points, other suitable places in the code can be used as switching points. For example, synchronisation points at which one or more threads switches from a runnable state to a non-runnable state, or from a non-runnable state to a runnable state, also constitute suitable switching points. Examples of synchronisation points include points in a thread which may require another parallel thread to catch up before the thread can continue execution.

Additionally, and particularly where there are an insufficient number of communication points or synchronisation points, switching points can be added into the code, either at compile-time by the compiler inserting thread yield instructions, or at run-time in the form of breakpoints. In the case of adding breakpoints, it is possible to force a context switch to happen at a particular point in the program by inserting a breakpoint and suspending a current thread when that breakpoint is reached.

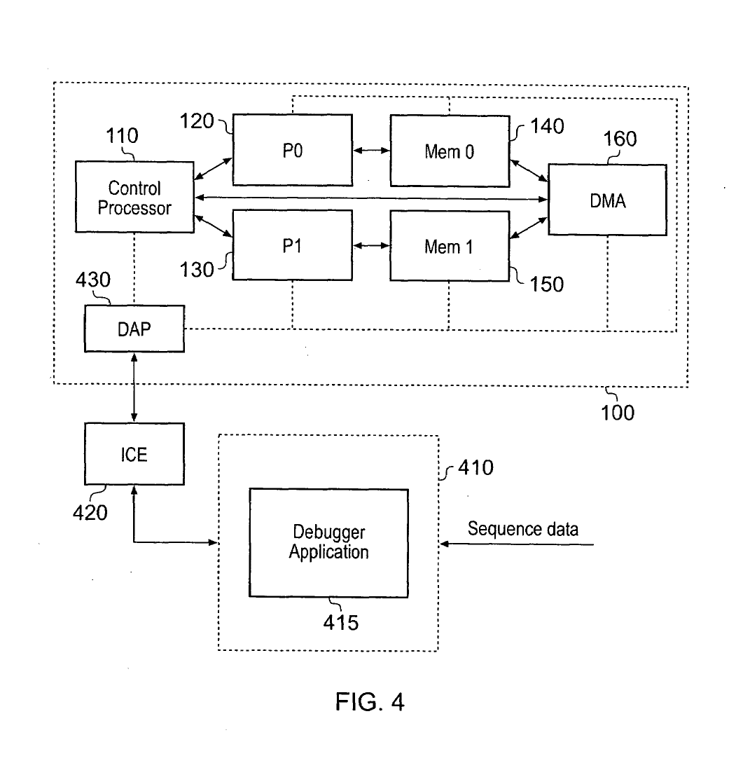

A debugging apparatus which utilises the above method is schematically illustrated with reference to FIG. 4. The data processing system 100 described with reference to FIG. 1 is shown in FIG. 4 with like reference numerals denoting like elements. The data processing system 100 is as described in FIG. 1 but is shown in FIG. 4 to include a Debug Access Port (DAP) 430 which enables an external device to access the control processor 110, the first processor 120, the second processor 130, the first memory 140, the second memory 15 and the DMA 160 for the purposes of debugging in accordance with the JTAG (Joint Test Action Group) standard. The external device in this case is an In-Circuit Emulator (ICE) 420 which sits between a development system 410 and the device to be tested, in this case the data processing system 100.

The ICE is a hardware device which enables the development system 410 to access the data processing system 100 via the Debug Access Port 430, and which enables programs to be loaded into the data processing system 100. The program so-loaded can be executed and/or stepped through under the control of the programmer. The development system 410 may be a dedicated test device or a general purpose computer, in either case being provided with a debugger application 415 which provides an interactive user interface for the programmer to investigate and control the data processing system 100.

In normal operation, the data processing system 100 will execute program code in accordance with a scheduling order defined by a scheduling function of the control processor 110. However, when operating in a debug mode under the control of the development system 410, program code is executed using an alternative scheduling order defined by the debugger application. This alternative scheduling order results from one or more rules intended to cause the program code to be executed in an order which follows an order of a source instruction stream from which the program code was compiled. In the present case, the rules are defined at least in part based on sequence data generated when the source instruction stream was compiled into the program code, and made available to the debugger application. The sequence data would represent an instruction order of the source instruction stream. Alternatively, in the absence of such sequence data, the rules may be based on an assumed instruction order of the source instruction stream. It will be appreciated that it may not always be possible to execute the program code in an order which identically matches the order of the source instruction stream, because to do so may in some circumstances result in the program failing to meet a deadline and thus causing an error. In other words, the present technique takes advantage of the flexibility which usually exists in the scheduling of program code execution, but as a result requires there to be some slack in the schedule because if it is not possible to delay execution of a task because a deadline would be missed, the present technique may not safely be applied to that task.

The present technique may slow execution to be less than that of the original sequential program. However, to overcome this, the program can be run at full speed (without rescheduling) until a particular event occurs and then switch to a slower debug mode (with rescheduling) while debugging the system. It is generally acceptable to run more slowly in a debug mode because the slowest part of the system is the programmer typing debug commands.

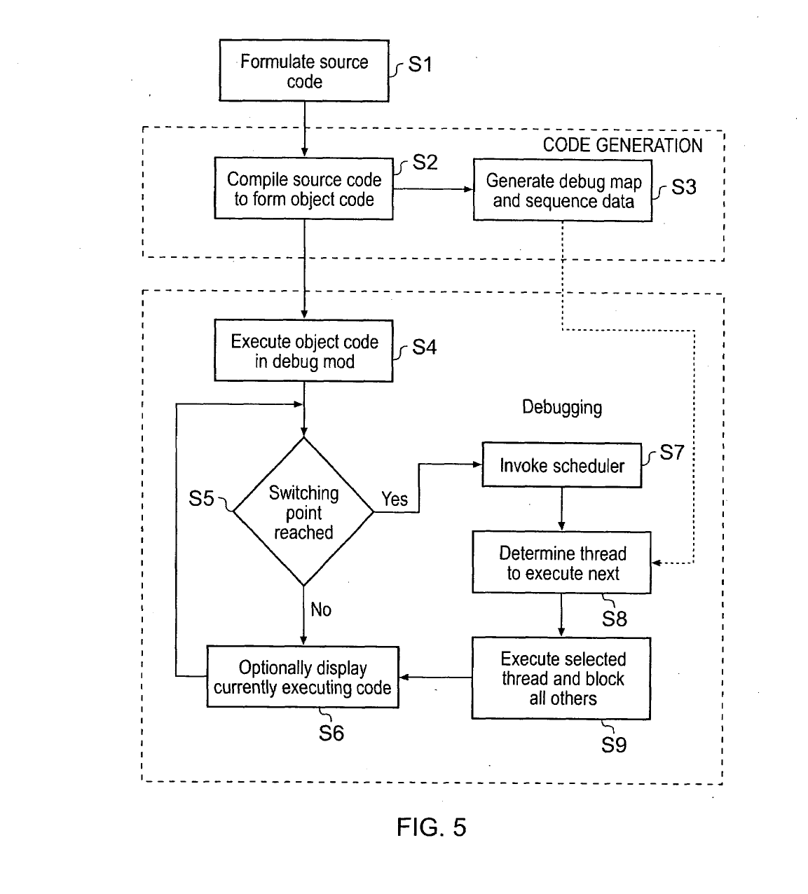

Referring to FIG. 5, a schematic flow diagram of the diagnostic method is provided. Firstly, at a step S1, source code is formulated to describe a program. At a step S2, the source code is compiled using a parallelising compiler to generate multi-threaded object code. The compilation process also generates, at a step S3, a debug map which provides a correspondence between instructions in the source code and instructions in the object code. The debug map includes sequence data which indicates the original order of instructions in the source code. Steps S2 and S3 are referred to as code generation steps. It will be appreciated that the source code could be pre-generated by a third party, in which case the step S1 will not be used.

The remaining steps relate to the debugging of the object code. At a step S4, the object code is executed in a debug mode. During execution, it is determined at a step S5 whether a switching point has been reached. As described above, the switching point could be a communication point, a synchronisation point or a thread yield instruction. If a switching point has not been reached, the currently executing code may optionally be displayed to the programmer as a debug view at a step S6. If however a switching point has been reached, the debug scheduler is invoked at a step S7. The scheduler determines, at a step S8, the next thread to be executed. This determination is conducted based on one or more rules, at least one of which is intended to force the instruction execution order of the object code to follow the order of the source code. At a step S9, the thread selected at the step S8 is executed, and all other threads are blocked. From the step S9, the process moves to the step S6, where the currently executing code may be displayed. In this way, the object code is executed sequentially, preferably in an order of the source code. It will be appreciated that, in some embodiments, the programmer may not be provided with a real time visual display, or may only be provided with a visual display periodically during execution of the code.

Although particular embodiments have been described herein, it will be appreciated that the invention is not limited thereto and that many modifications and additions thereto may be made within the scope of the invention. For example, various combinations of the features of the following dependent claims can be made with the features of the independent claims without departing from the scope of the present invention.

We claim:

1. A diagnostic method for generating diagnostic data relating to processing of an instruction stream, wherein said instruction stream has been compiled from a source instruction stream to include multiple threads, said method comprising the steps of:
(i) initiating a diagnostic procedure in which at least a portion of said instruction stream is executed;
(ii) controlling a scheduling order for executing instructions within said at least a portion of said instruction stream to cause execution of a sequence of thread portions, said sequence being determined in response to one or more rules, at least one of said rules defining an order of execution of said thread portions to follow an order of said source instruction stream.

2. A diagnostic method according to claim 1, wherein said at least one of said rules defines an order of execution of said thread portions which substantially matches an order of said source instruction stream.

3. A diagnostic method according to claim 1, wherein at least some of said threads can be processed in parallel.

4. A diagnostic method according to any claim 1, wherein at least one of said one or more rules comprises:
(i) detecting when execution of a currently executing thread reaches a switching point in said instruction stream, and blocking said currently executing thread from further execution; and
(ii) determining a currently inactive thread which is runnable, and executing said instruction stream associated with said currently inactive thread.

5. A diagnostic method according to claim 4, wherein at least one of said one or more rules comprises inhibiting parallel execution of multiple threads.

6. A diagnostic method according to claim 4, wherein said switching point is a communication point between threads which occurs when said currently executing thread makes a value available to another thread.

7. A diagnostic method according to claim 4, wherein said switching point is a synchronisation point at which one or more threads switches from a runnable state to a non-runnable state, or from a non-runnable state to a runnable state.

8. A diagnostic method according to claim 4, wherein said switching point is a thread yield instruction added by a compiler when said source instruction stream is compiled.

9. A diagnostic method according to claim 8, wherein said thread yield instruction is added to a thread when a compilation of an instruction from said source instruction stream does not generate a corresponding instruction in that thread.

10. A diagnostic method according to claim 4, wherein said switching point is a breakpoint added during execution of said instruction stream.

11. A diagnostic method according to claim 10, wherein a position of said breakpoint is determined from data generated by a compiler during a compilation of said source instruction stream.

12. A diagnostic method according to any claim 1, wherein said one or more rules are generated from sequence data generated during compilation of said instruction stream from said source instruction stream, said sequence data being indicative of an order of said source instruction stream.

13. A diagnostic apparatus for generating diagnostic data relating to processing of an instruction stream, wherein said instruction stream has been compiled from a source instruction stream to include multiple threads, said diagnostic apparatus comprising:
(i) a diagnostic engine for initiating a diagnostic procedure in which at least a portion of said instruction stream is executed; and
(ii) a scheduling controller for controlling a scheduling order for executing instructions within said at least a portion of said instruction stream to cause execution of a sequence of thread portions determined in response to one or more rules, at least one of said rules defining an order of execution of said thread portions to follow an order of said source instruction stream.

14. A diagnostic apparatus according to claim 13, wherein said at least one of said rules defines an order of execution of said thread portions which substantially matches an order of said source instruction stream.

15. A diagnostic apparatus according to claim 13, wherein at least some of said threads can be processed in parallel.

16. A diagnostic apparatus according to claim 13, wherein at least one of said one or more rules comprises:
(i) detecting when execution of a currently executing thread reaches a switching point in said instruction stream, and blocking said currently executing thread from further execution; and
(ii) determining a currently inactive thread which is runnable, and executing said instruction stream associated with said currently inactive thread.

17. A diagnostic apparatus according to claim 16, wherein at least one of said one or more rules comprises inhibiting parallel execution of multiple threads.

18. A diagnostic apparatus according to claim 16, wherein said switching point is a communication point between threads which occurs when said currently executing thread makes a value available to another thread.

19. A diagnostic apparatus according to claim 16, wherein said switching point is a synchronisation point at which one or more threads switches from a runnable state to a non-runnable state, or from a non-runnable state to a runnable state.

20. A diagnostic apparatus according to claim 16, wherein said switching point is a thread yield instruction added by a compiler when said source instruction stream is compiled.

21. A diagnostic apparatus according to claim 20, wherein said thread yield instruction is added to a thread when a compilation of an instruction from said source instruction stream does not generate a corresponding instruction in that thread.

22. A diagnostic apparatus according to claim 16, wherein said switching point is a breakpoint added during execution of said instruction stream.

23. A diagnostic apparatus according to claim 22, wherein a position of said breakpoint is determined from data generated by a compiler during a compilation of said source instruction stream.

24. A diagnostic apparatus according to claim 13, wherein said one or more rules are generated from sequence data generated during compilation of said instruction stream from said source instruction stream, said sequence data being indicative of an order of said source instruction stream.

25. A method of compiling an instruction stream from a source instruction stream to include multiple threads, comprising the step of:
(i) generating sequence data during compilation of said source instruction stream, said sequence data being indicative of an order of said source instruction stream.

26. A parallelising compiler for compiling an instruction stream from a source instruction stream to include multiple threads, the compiler comprising:
(i) a sequence data generator operable to generate sequence data during compilation of said source instruction stream, said sequence data being indicative of an order of said source instruction stream.

27. A computer program product which is operable when run on a data processor to control the data processor to perform the steps of the method according to claim 1.
